(19) United States
(12) Patent Application Publication
(10) Pub. No.: US 2006/0059890 A1
(43) Pub. Date: Mar. 23, 2006

(54) Rotor blade for a first phase of a gas turbine

(75) Inventors: Giuseppe Sassanelli, Sesto Fiorentino (Florence) (IT); Marco Boncinelli, Scandicci (Florence) (IT)

Correspondence Address: NIXON & VANDERHYE, PC, 901 NORTH GLEBE ROAD, 11TH FLOOR, ARLINGTON, VA, 22203, US

(73) Assignee: Nuovo Pignone S.p.A., Florence (IT)

(21) Appl. No.: 11/226,264

(22) Filed: Sep. 15, 2005

(30) Foreign Application Priority Data
Sep. 21, 2004 (IT) MI2004A 001804

(51) Int. Cl. F02K 1/00

(52) U.S. Cl. 60/230

(57) ABSTRACT

Blade (1) of a rotor for a first phase of a gas turbine having a profile identified by means of a series of closed intersection curves (20) between the profile itself and planes (X,Y) lying at distances (Z) from the central axis, each closed curve (20) has a first rounded end (21) and a second rounded end (22), which connect the trace of the first surface (3) with the trace of the second surface (5) in depression, the first end (21) first meets a gas flow of the turbine, each closed curve (20) has an axial chord (40) defined as the maximum distance of the first end (21) from the second end (22) along the axis (X), each closed curve (20) has a thickness (30) of the first end (21) defined as the maximum diameter of the circle inscribed in the first end (21); said dimensionless thickness (30), i.e. divided by the axial chord (40), has a quadric distribution according to a curve of the fourth order along the axis (Z).

The present invention relates to a rotor blade for a first phase of a gas turbine.

Gas turbine refers to a rotating thermal machine which converts the enthalpy of a gas into useful energy, using gases coming from a combustion, and which supplies mechanical power on a rotating shaft.

The turbine therefore normally comprises a compressor or turbo-compressor, inside which the air taken from the outside environment is brought under pressure.

Various injectors feed the fuel which is mixed with the air to form an air-fuel ignition mixture.

The axial compressor is entrained by a turbine, in the true sense, i.e. a turbo-expander, which supplies mechanical energy to a user transforming the enthalpy of the gases combusted in the combustion chamber.

In applications for the generation of mechanical energy, the expansion jump is subdivided into two partial jumps, each of which takes place inside a turbine. The high-pressure turbine, downstream of the combustion chamber, entrains the compressor. The low-pressure turbine, which collects the gases coming from the high-pressure turbine, is then connected to a user.

The turbo-expander, turbo-compressor, combustion chamber (or heater), outlet shaft, regulation system and ignition system, form the essential parts of a gas turbine plant.

As far as the functioning of a gas turbine is concerned, it is known that the fluid penetrates the compressor through a series of inlet ducts.

In these canalizations, the gas has low-pressure and low-temperature characteristics, whereas, as it passes through the compressor, the gas is compressed and its temperature increases.

It then penetrates into the combustion (or heating) chamber, where it undergoes a further significant increase in temperature.

The heat necessary for the temperature increase of the gas is supplied by the combustion of liquid fuel introduced into the heating chamber, by means of injectors.

The triggering of the combustion, when the machine is activated, is obtained by means of sparking plugs.

At the outlet of the combustion chamber, the high-pressure and high-temperature gas reaches the turbine, through specific ducts, where it gives up part of the energy accumulated in the compressor and heating chamber (combustor) and then flows outside by means of the discharge channels.

As the energy conferred by the gas to the turbine is greater than that absorbed thereby in the compressor, a certain quantity of energy remains available, on the shaft of the machine, which purified of the work absorbed by the accessories and passive resistances of the moving mechanical organs, forms the useful work of the plant.

As a result of the high specific energy made available, the turbines in the true sense, i.e. the turbo-expanders, are generally multi-phase to optimize the yield of the energy transformation transferred by the gas into useful work.

The phase is therefore the constitutive element for each section of a turbine and comprises a stator and a rotor, each equipped with a series of blades.

One of the main requisites common to all turbines, however, is linked to the high efficiency which must be obtained for operating on all the components of the turbine.

In recent years, technologically avant-garde turbines have been further improved, by raising the thermodynamic cycle parameters such as combustion temperature, pressure changes, efficacy of the cooling system and components of the turbine.

Nowadays, for a further improvement in efficiency, it is necessary to operate on the aerodynamic parameters of the profiles of the blade system.

The geometrical configuration of the blade system significantly influences the aerodynamic efficiency.

This depends on the fact that the geometrical characteristics of the blade determine the distribution of the relative fluid rates, consequently influencing the distribution of the limit layers along the walls and, last but not least, friction losses.

In a low-pressure turbine, it is observed that the rotation rate operating conditions can vary from 50% to 105% of the nominal rate and consequently, the blade system of the turbines must maintain a high aerodynamic efficiency within a very wide range.

Particularly in the case of rotor blades of a first phase of a low-pressure turbine, an extremely high efficiency is required, at the same time maintaining an appropriate aerodynamic and mechanical load.

At present, it is difficult to have blades which allow a high efficiency with variations in the functioning conditions of the turbine and which, at the same time, are capable of maintaining a useful life.

An objective of the present invention is to provide a rotor blade for a first phase of a gas turbine which allows high aerodynamic performances within a wide functioning range.

A further objective is to provide a rotor blade for a first phase of a gas turbine which, at the same time, enables a high useful life of the component itself.

Another objective is to provide a rotor blade for a first phase of a gas turbine which allows high aerodynamic performances within a wide functioning range and which, at the same time, enables a useful life of the component itself.

These objectives according to the present invention are achieved by providing a rotor blade for a first phase of a gas turbine as specified in claim 1.

Further characteristics of the invention are indicated in the subsequent claims.

The characteristics and advantages of a rotor blade for a first phase of a gas turbine according to the present invention will appear more evident from the following, illustrative and non-limiting description, referring to the enclosed schematic drawings in which:

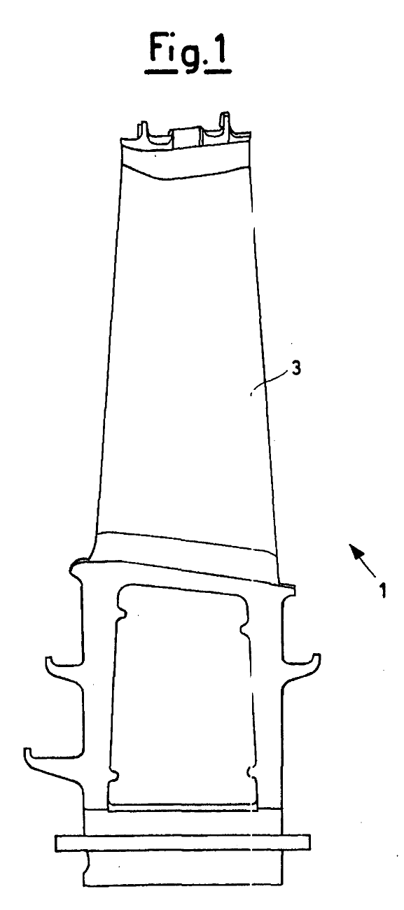

FIG. 1 is a raised view of a blade of the rotor of a turbine produced with the aerodynamic profile according to the invention;

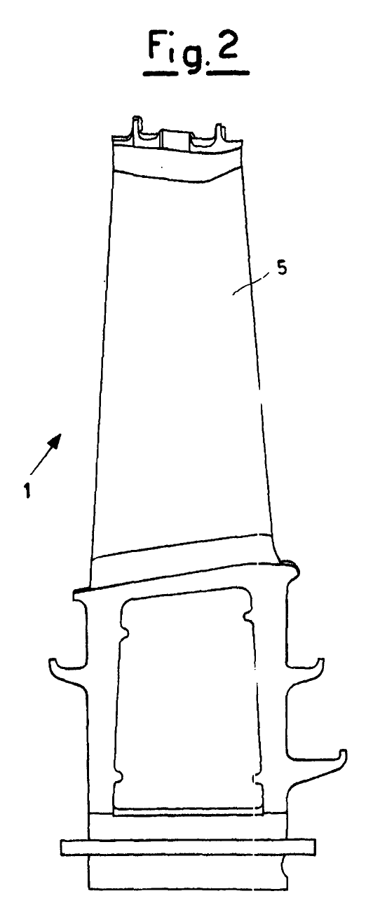

FIG. 2 is a raised view of the opposite side of the blade of FIG. 1;

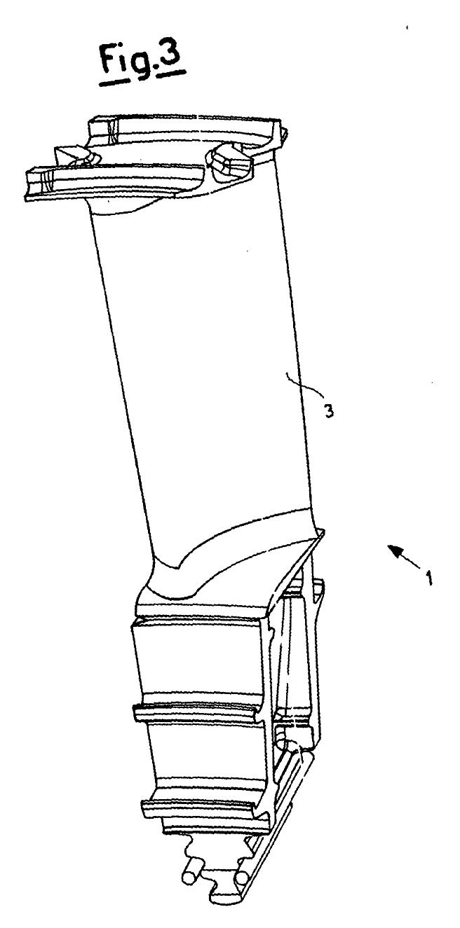

FIG. 3 is a raised perspective left side view of a blade according to the invention;

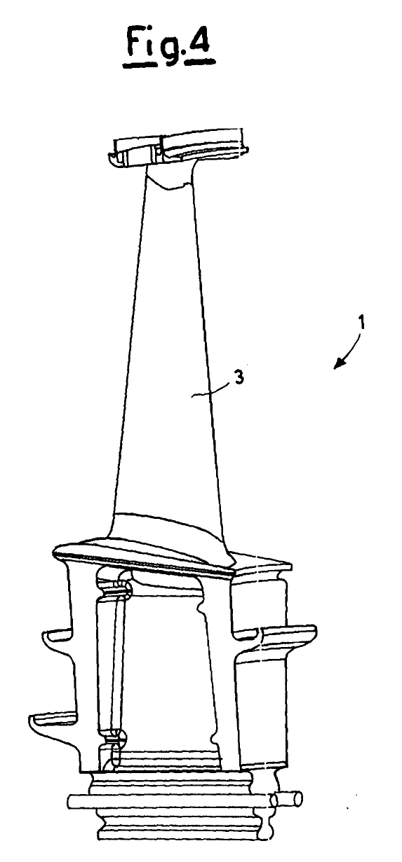

FIG. 4 is a raised perspective right side view of a blade according to the invention;

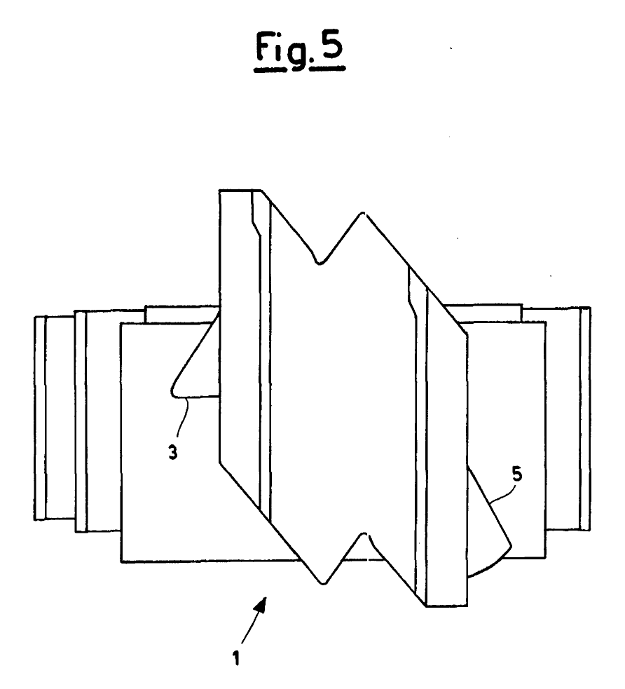

FIG. 5 is a view from above of a blade according to the invention;

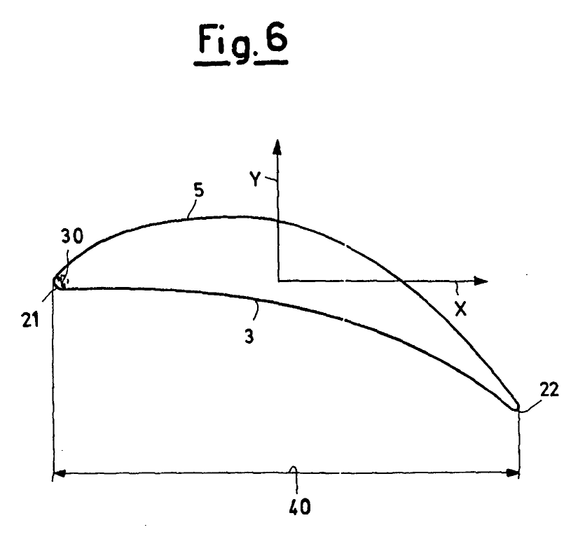

FIG. 6 is a sectional view of a blade according to the invention.

With reference to the figures, these show a blade 1 of a rotor for a first phase of a gas turbine.

Said blade 1 is inserted together with a series of blades onto a rotor of said gas turbine.

Said blade 1 is defined by means of coordinates of a discreet combination of points, in a Cartesian reference system X,Y,Z, wherein the axis Z is a radial axis intersecting the central axis of the turbine.

Said blade 1 has a profile which is defined by means of a series of closed intersection curves 20 between the profile itself and planes (X,Y) lying at distances Z from the central axis.

The profile of said blade 1 comprises a first concave surface 3, which is under pressure, and a second convex surface 5 which is in depression and which is opposite to the first.

The two surfaces 3, 5 are continuous and jointly form the profile of each blade 1.

At the ends, according to the known art, there is a connector between each blade 1 and the rotor itself.

Each closed curve 20 is substantially “C”-shaped, having a first rounded end 21 and a second rounded end 22, which connect the trace of the first surface 3 with the trace of the second surface 5 in depression.

Said first end 21 at the inlet of each closed curve is that which the gas flow first comes in contact with.

The thickness 30 of said first end 21 is defined as the maximum diameter of the circle inscribed in said first end 21.

Said thickness 30 of each closed curve 20 greatly influences the aerodynamic operating conditions of the blade 1 which are different from the project conditions.

Said thickness 30 is dimensionless with respect to the axial chord 40 defined as the maximum distance of the first end 21 from the second end 22 along the axis X.

Said dimensionless thickness 30, i.e. divided by the axial chord 40, has a distribution along the axis Z which allows a high aerodynamic efficiency to be obtained within a wide functioning range of the gas turbine.

Said dimensionless thickness 30 has a quadric distribution along the axis Z.

Starting from the base of said blade 1 along the axis Z, said quadric distribution has initially decreasing and then increasing values.

In this way, it is possible to maintain a high useful life of the blade 1 and also have a high aerodynamic efficiency which is constant, or only slightly varying, within a wide functioning range of the gas turbine.

This advantageously proves to be extremely useful when a variable nozzle is used, which greatly varies the fluid-dynamic conditions of the gas flow at the inlet of the first phase rotor.

According to a further aspect of the present invention, a rotor is provided for a first phase of a gas turbine equipped with a variable suction nozzle, said rotor comprising a series of shaped blades 1, each of which having a shaped aerodynamic profile.

The aerodynamic profile of each blade 1 is defined by means of a series of closed curves 20 whose coordinates are defined with respect to a Cartesian reference system X,Y,Z, wherein the axis Z is a radial axis intersecting the central axis of the turbine, and said closed curves 20 lying at distances Z from the central axis, are defined according to Table I, whose values of each closed curve 20 refer to a room temperature profile and are divided by value, expressed in millimetres, of the axial chord 40 along the axis X, indicated in Table I with CHX.

TABLE I

| X/CHX | Y/CHX | Z/CHX |
|---|---|---|
| −0.480297 | −0.026870 | 6.484508 |
| −0.481925 | −0.025509 | 6.484508 |
| −0.483739 | −0.023341 | 6.484508 |
| −0.485465 | −0.020259 | 6.484508 |
| −0.486864 | −0.016262 | 6.484508 |
| −0.487805 | −0.010702 | 6.484508 |
| −0.487691 | −0.003349 | 6.484508 |
| −0.486035 | 0.005680 | 6.484508 |
| −0.482433 | 0.016237 | 6.484508 |
| −0.476566 | 0.028148 | 6.484508 |
| −0.468143 | 0.041218 | 6.484508 |
| −0.456753 | 0.055643 | 6.484508 |
| −0.442359 | 0.071223 | 6.484508 |
| −0.424967 | 0.087822 | 6.484508 |
| −0.404572 | 0.105318 | 6.484508 |
| −0.381096 | 0.123506 | 6.484508 |
| −0.354239 | 0.141859 | 6.484508 |
| −0.324979 | 0.159064 | 6.484508 |
| −0.293230 | 0.174621 | 6.484508 |
| −0.258989 | 0.187995 | 6.484508 |
| −0.222335 | 0.198628 | 6.484508 |
| −0.183420 | 0.205913 | 6.484508 |
| −0.142548 | 0.209226 | 6.484508 |
| −0.100155 | 0.208004 | 6.484508 |
| −0.058172 | 0.202100 | 6.484508 |
| −0.017062 | 0.191690 | 6.484508 |
| 0.022772 | 0.177126 | 6.484508 |
| 0.061059 | 0.158832 | 6.484508 |
| 0.097635 | 0.137364 | 6.484508 |
| 0.132445 | 0.113106 | 6.484508 |
| 0.165577 | 0.086618 | 6.484508 |
| 0.197115 | 0.058253 | 6.484508 |
| 0.227185 | 0.028309 | 6.484508 |
| 0.255922 | −0.002911 | 6.484508 |
| 0.283412 | −0.035226 | 6.484508 |
| 0.308877 | −0.067385 | 6.484508 |
| 0.332517 | −0.099154 | 6.484508 |
| 0.354471 | −0.130403 | 6.484508 |
| 0.374897 | −0.160982 | 6.484508 |
| 0.393905 | −0.190799 | 6.484508 |
| 0.411614 | −0.219759 | 6.484508 |
| 0.428107 | −0.247799 | 6.484508 |
| 0.442792 | −0.273617 | 6.484508 |
| 0.455781 | −0.297147 | 6.484508 |
| 0.467180 | −0.318318 | 6.484508 |
| 0.477061 | −0.337091 | 6.484508 |
| 0.485495 | −0.353423 | 6.484508 |
| 0.492538 | −0.367284 | 6.484508 |
| 0.498488 | −0.379162 | 6.484508 |
| 0.503440 | −0.389169 | 6.484508 |
| 0.507480 | −0.397419 | 6.484508 |
| 0.510690 | −0.404029 | 6.484508 |
| 0.512195 | −0.409449 | 6.484508 |
| 0.511663 | −0.413694 | 6.484508 |
| 0.510230 | −0.416796 | 6.484508 |
| 0.508456 | −0.418925 | 6.484508 |
| 0.506757 | −0.420322 | 6.484508 |
| −0.478880 | −0.027746 | 6.484508 |
| −0.476846 | −0.028634 | 6.484508 |
| −0.474179 | −0.029391 | 6.484508 |
| −0.470902 | −0.029972 | 6.484508 |
| −0.466486 | −0.030437 | 6.484508 |
| −0.460721 | −0.030756 | 6.484508 |
| −0.453505 | −0.030941 | 6.484508 |
| −0.444735 | −0.030855 | 6.484508 |
| −0.434301 | −0.030539 | 6.484508 |
| −0.422092 | −0.030143 | 6.484508 |
| −0.407664 | −0.029671 | 6.484508 |
| −0.391013 | −0.029224 | 6.484508 |
| −0.372137 | −0.028908 | 6.484508 |
| −0.351038 | −0.028833 | 6.484508 |
| −0.327721 | −0.029126 | 6.484508 |
| −0.302193 | −0.029938 | 6.484508 |
| −0.275583 | −0.031399 | 6.484508 |
| −0.247906 | −0.033564 | 6.484508 |
| −0.219183 | −0.036488 | 6.484508 |
| −0.189436 | −0.040236 | 6.484508 |
| −0.158691 | −0.044869 | 6.484508 |
| −0.126975 | −0.050448 | 6.484508 |
| −0.094318 | −0.057033 | 6.484508 |
| −0.061838 | −0.064435 | 6.484508 |
| −0.029557 | −0.072662 | 6.484508 |
| 0.002500 | −0.081725 | 6.484508 |
| 0.034303 | −0.091646 | 6.484508 |
| 0.065811 | −0.102462 | 6.484508 |
| 0.096988 | −0.114202 | 6.484508 |
| 0.127778 | −0.126916 | 6.484508 |
| 0.158131 | −0.140636 | 6.484508 |
| 0.187998 | −0.155394 | 6.484508 |
| 0.217312 | −0.171218 | 6.484508 |
| 0.246012 | −0.188127 | 6.484508 |
| 0.273122 | −0.205509 | 6.484508 |
| 0.298647 | −0.223257 | 6.484508 |
| 0.322622 | −0.241262 | 6.484508 |
| 0.345077 | −0.259405 | 6.484508 |
| 0.366059 | −0.277583 | 6.484508 |
| 0.385623 | −0.295680 | 6.484508 |
| 0.403823 | −0.313598 | 6.484508 |
| 0.419965 | −0.330425 | 6.484508 |
| 0.434174 | −0.346026 | 6.484508 |
| 0.446564 | −0.360266 | 6.484508 |
| 0.457243 | −0.373049 | 6.484508 |
| 0.466300 | −0.384279 | 6.484508 |
| 0.473823 | −0.393892 | 6.484508 |
| 0.480150 | −0.402187 | 6.484508 |
| 0.485395 | −0.409217 | 6.484508 |
| 0.489662 | −0.415040 | 6.484508 |
| 0.493435 | −0.419374 | 6.484508 |
| 0.497183 | −0.421642 | 6.484508 |
| 0.500462 | −0.422172 | 6.484508 |
| 0.503201 | −0.421866 | 6.484508 |
| 0.505266 | −0.421144 | 6.484508 |
| −0.467580 | 0.002293 | 6.895319 |
| −0.469157 | 0.003641 | 6.895319 |
| −0.470920 | 0.005770 | 6.895319 |
| −0.472564 | 0.008806 | 6.895319 |
| −0.473811 | 0.012748 | 6.895319 |
| −0.474456 | 0.018225 | 6.895319 |
| −0.473919 | 0.025389 | 6.895319 |
| −0.471771 | 0.034100 | 6.895319 |
| −0.467670 | 0.044204 | 6.895319 |
| −0.461350 | 0.055542 | 6.895319 |
| −0.452555 | 0.067941 | 6.895319 |
| −0.440882 | 0.081601 | 6.895319 |
| −0.426254 | 0.096295 | 6.895319 |
| −0.408640 | 0.111853 | 6.895319 |
| −0.387992 | 0.128089 | 6.895319 |
| −0.364188 | 0.144702 | 6.895319 |
| −0.336943 | 0.161094 | 6.895319 |
| −0.307292 | 0.175984 | 6.895319 |
| −0.275228 | 0.188873 | 6.895319 |
| −0.240823 | 0.199231 | 6.895319 |
| −0.204235 | 0.206517 | 6.895319 |
| −0.165711 | 0.210184 | 6.895319 |
| −0.125632 | 0.209723 | 6.895319 |
| −0.084477 | 0.204712 | 6.895319 |
| −0.044116 | 0.195279 | 6.895319 |
| −0.004946 | 0.181715 | 6.895319 |
| 0.032747 | 0.164443 | 6.895319 |
| 0.068793 | 0.143914 | 6.895319 |
| 0.103132 | 0.120680 | 6.895319 |
| 0.135773 | 0.095094 | 6.895319 |
| 0.166845 | 0.067634 | 6.895319 |
| 0.196456 | 0.038603 | 6.895319 |
| 0.224730 | 0.008252 | 6.895319 |
| 0.251794 | −0.023182 | 6.895319 |
| 0.277745 | −0.055532 | 6.895319 |
| 0.301835 | −0.087586 | 6.895319 |
| 0.324250 | −0.119146 | 6.895319 |
| 0.345119 | −0.150100 | 6.895319 |
| 0.364580 | −0.180323 | 6.895319 |
| 0.382733 | −0.209737 | 6.895319 |
| 0.399682 | −0.238265 | 6.895319 |
| 0.415505 | −0.265848 | 6.895319 |
| 0.429621 | −0.291220 | 6.895319 |
| 0.442131 | −0.314323 | 6.895319 |
| 0.453128 | −0.335096 | 6.895319 |
| 0.462674 | −0.353505 | 6.895319 |
| 0.470833 | −0.369514 | 6.895319 |
| 0.477655 | −0.383097 | 6.895319 |
| 0.483423 | −0.394732 | 6.895319 |
| 0.488227 | −0.404532 | 6.895319 |
| 0.492150 | −0.412610 | 6.895319 |
| 0.495269 | −0.419081 | 6.895319 |
| 0.496697 | −0.424388 | 6.895319 |
| 0.496130 | −0.428534 | 6.895319 |
| 0.494700 | −0.431547 | 6.895319 |
| 0.492944 | −0.433611 | 6.895319 |
| 0.491269 | −0.434964 | 6.895319 |
| −0.466191 | 0.001401 | 6.895319 |
| −0.464199 | 0.000467 | 6.895319 |
| −0.461579 | −0.000360 | 6.895319 |
| −0.458345 | −0.001006 | 6.895319 |
| −0.453973 | −0.001493 | 6.895319 |
| −0.448257 | −0.001747 | 6.895319 |
| −0.441105 | −0.001763 | 6.895319 |
| −0.432419 | −0.001455 | 6.895319 |
| −0.422089 | −0.000900 | 6.895319 |
| −0.409997 | −0.000342 | 6.895319 |
| −0.395700 | 0.000150 | 6.895319 |
| −0.379196 | 0.000444 | 6.895319 |
| −0.360489 | 0.000405 | 6.895319 |
| −0.339588 | −0.000107 | 6.895319 |
| −0.316507 | −0.001242 | 6.895319 |
| −0.291271 | −0.003161 | 6.895319 |
| −0.265003 | −0.005902 | 6.895319 |
| −0.237732 | −0.009518 | 6.895319 |
| −0.209485 | −0.014061 | 6.895319 |
| −0.180293 | −0.019587 | 6.895319 |
| −0.150188 | −0.026145 | 6.895319 |
| −0.119205 | −0.033789 | 6.895319 |
| −0.087382 | −0.042572 | 6.895319 |
| −0.055811 | −0.052220 | 6.895319 |
| −0.024515 | −0.062723 | 6.895319 |
| 0.006483 | −0.074078 | 6.895319 |
| 0.037154 | −0.086292 | 6.895319 |
| 0.067462 | −0.099377 | 6.895319 |
| 0.097374 | −0.113345 | 6.895319 |
| 0.126845 | −0.128217 | 6.895319 |
| 0.155834 | −0.144004 | 6.895319 |
| 0.184303 | −0.160720 | 6.895319 |
| 0.212205 | −0.178364 | 6.895319 |
| 0.239495 | −0.196935 | 6.895319 |
| 0.265263 | −0.215761 | 6.895319 |
| 0.289535 | −0.234736 | 6.895319 |
| 0.312356 | −0.253763 | 6.895319 |
| 0.333772 | −0.272734 | 6.895319 |
| 0.353833 | −0.291557 | 6.895319 |
| 0.372601 | −0.310138 | 6.895319 |
| 0.390128 | −0.328396 | 6.895319 |
| 0.405743 | −0.345430 | 6.895319 |
| 0.419553 | −0.361133 | 6.895319 |
| 0.431655 | −0.375397 | 6.895319 |
| 0.442133 | −0.388149 | 6.895319 |
| 0.451063 | −0.399315 | 6.895319 |
| 0.458511 | −0.408846 | 6.895319 |
| 0.464798 | −0.417052 | 6.895319 |
| 0.470025 | −0.423992 | 6.895319 |
| 0.474289 | −0.429733 | 6.895319 |
| 0.478050 | −0.434006 | 6.895319 |
| 0.481771 | −0.436243 | 6.895319 |
| 0.485021 | −0.436768 | 6.895319 |
| 0.487737 | −0.436473 | 6.895319 |
| 0.489787 | −0.435767 | 6.895319 |
| −0.456009 | 0.028415 | 7.291442 |
| −0.457535 | 0.029762 | 7.291442 |
| −0.459242 | 0.031869 | 7.291442 |
| −0.460803 | 0.034874 | 7.291442 |
| −0.461907 | 0.038770 | 7.291442 |
| −0.462276 | 0.044168 | 7.291442 |
| −0.461348 | 0.051149 | 7.291442 |
| −0.458745 | 0.059552 | 7.291442 |
| −0.454179 | 0.069224 | 7.291442 |
| −0.447434 | 0.080022 | 7.291442 |
| −0.438284 | 0.091794 | 7.291442 |
| −0.426322 | 0.104734 | 7.291442 |
| −0.411444 | 0.118595 | 7.291442 |
| −0.393591 | 0.133172 | 7.291442 |
| −0.372687 | 0.148222 | 7.291442 |
| −0.348574 | 0.163352 | 7.291442 |
| −0.320995 | 0.177902 | 7.291442 |
| −0.291047 | 0.190624 | 7.291442 |
| −0.258791 | 0.201013 | 7.291442 |
| −0.224372 | 0.208553 | 7.291442 |
| −0.188027 | 0.212731 | 7.291442 |
| −0.150079 | 0.213078 | 7.291442 |
| −0.110962 | 0.209205 | 7.291442 |
| −0.071172 | 0.200838 | 7.291442 |
| −0.032484 | 0.188349 | 7.291442 |
| 0.004792 | 0.172125 | 7.291442 |
| 0.040472 | 0.152620 | 7.291442 |
| 0.074477 | 0.130288 | 7.291442 |
| 0.106827 | 0.105647 | 7.291442 |
| 0.137582 | 0.079034 | 7.291442 |
| 0.166882 | 0.050828 | 7.291442 |
| 0.194847 | 0.021296 | 7.291442 |
| 0.221597 | −0.009349 | 7.291442 |
| 0.247250 | −0.040920 | 7.291442 |
| 0.271901 | −0.073272 | 7.291442 |
| 0.294834 | −0.105216 | 7.291442 |
| 0.316219 | −0.136584 | 7.291442 |
| 0.336177 | −0.167277 | 7.291442 |
| 0.354828 | −0.197193 | 7.291442 |
| 0.372263 | −0.226263 | 7.291442 |
| 0.388574 | −0.254422 | 7.291442 |
| 0.403834 | −0.281620 | 7.291442 |
| 0.417471 | −0.306616 | 7.291442 |
| 0.429577 | −0.329360 | 7.291442 |
| 0.440234 | −0.349800 | 7.291442 |
| 0.449497 | −0.367905 | 7.291442 |
| 0.457423 | −0.383643 | 7.291442 |
| 0.464057 | −0.396992 | 7.291442 |
| 0.469672 | −0.408425 | 7.291442 |
| 0.474352 | −0.418051 | 7.291442 |
| 0.478176 | −0.425984 | 7.291442 |
| 0.481217 | −0.432339 | 7.291442 |
| 0.482583 | −0.437551 | 7.291442 |
| 0.481991 | −0.441613 | 7.291442 |
| 0.480562 | −0.444552 | 7.291442 |
| 0.478822 | −0.446562 | 7.291442 |
| 0.477167 | −0.447876 | 7.291442 |
| −0.454647 | 0.027500 | 7.291442 |
| −0.452695 | 0.026516 | 7.291442 |
| −0.450117 | 0.025617 | 7.291442 |
| −0.446921 | 0.024895 | 7.291442 |
| −0.442583 | 0.024359 | 7.291442 |
| −0.436904 | 0.024112 | 7.291442 |
| −0.429798 | 0.024186 | 7.291442 |
| −0.421173 | 0.024630 | 7.291442 |
| −0.410919 | 0.025340 | 7.291442 |
| −0.398908 | 0.025988 | 7.291442 |
| −0.384700 | 0.026448 | 7.291442 |
| −0.368299 | 0.026558 | 7.291442 |
| −0.349715 | 0.026155 | 7.291442 |
| −0.328968 | 0.025076 | 7.291442 |
| −0.306087 | 0.023153 | 7.291442 |
| −0.281111 | 0.020212 | 7.291442 |
| −0.255163 | 0.016292 | 7.291442 |
| −0.228279 | 0.011345 | 7.291442 |
| −0.200494 | 0.005327 | 7.291442 |
| −0.171847 | −0.001806 | 7.291442 |
| −0.142375 | −0.010097 | 7.291442 |
| −0.112119 | −0.019589 | 7.291442 |
| −0.081123 | −0.030326 | 7.291442 |
| −0.050452 | −0.041958 | 7.291442 |
| −0.020126 | −0.054463 | 7.291442 |
| 0.009833 | −0.067822 | 7.291442 |
| 0.039403 | −0.082028 | 7.291442 |
| 0.068552 | −0.097072 | 7.291442 |
| 0.097257 | −0.112950 | 7.291442 |
| 0.125483 | −0.129661 | 7.291442 |
| 0.153201 | −0.147201 | 7.291442 |
| 0.180383 | −0.165564 | 7.291442 |
| 0.207002 | −0.184735 | 7.291442 |
| 0.233031 | −0.204694 | 7.291442 |
| 0.257615 | −0.224725 | 7.291442 |
| 0.280796 | −0.244723 | 7.291442 |
| 0.302624 | −0.264602 | 7.291442 |
| 0.323154 | −0.284269 | 7.291442 |
| 0.342439 | −0.303642 | 7.291442 |
| 0.360540 | −0.322644 | 7.291442 |
| 0.377508 | −0.341206 | 7.291442 |
| 0.392687 | −0.358436 | 7.291442 |
| 0.406167 | −0.374248 | 7.291442 |
| 0.418031 | −0.388558 | 7.291442 |
| 0.428344 | −0.401310 | 7.291442 |
| 0.437169 | −0.412444 | 7.291442 |
| 0.444555 | −0.421926 | 7.291442 |
| 0.450807 | −0.430074 | 7.291442 |
| 0.456020 | −0.436954 | 7.291442 |
| 0.460280 | −0.442637 | 7.291442 |
| 0.464026 | −0.446874 | 7.291442 |
| 0.467720 | −0.449104 | 7.291442 |
| 0.470948 | −0.449635 | 7.291442 |
| 0.473649 | −0.449354 | 7.291442 |
| 0.475690 | −0.448664 | 7.291442 |
| −0.431225 | 0.082430 | 8.222230 |
| −0.432602 | 0.083820 | 8.222230 |
| −0.434116 | 0.085946 | 8.222230 |
| −0.435408 | 0.088933 | 8.222230 |
| −0.436112 | 0.092756 | 8.222230 |
| −0.435821 | 0.097949 | 8.222230 |
| −0.434000 | 0.104465 | 8.222230 |
| −0.430387 | 0.112111 | 8.222230 |
| −0.424802 | 0.120747 | 8.222230 |
| −0.417104 | 0.130268 | 8.222230 |
| −0.407132 | 0.140567 | 8.222230 |
| −0.394444 | 0.151797 | 8.222230 |
| −0.378904 | 0.163659 | 8.222230 |
| −0.360418 | 0.175878 | 8.222230 |
| −0.338880 | 0.188094 | 8.222230 |
| −0.314106 | 0.199715 | 8.222230 |
| −0.285943 | 0.209979 | 8.222230 |
| −0.255647 | 0.217759 | 8.222230 |
| −0.223426 | 0.222550 | 8.222230 |
| −0.189581 | 0.223903 | 8.222230 |
| −0.154498 | 0.221451 | 8.222230 |
| −0.118605 | 0.214930 | 8.222230 |
| −0.082359 | 0.204237 | 8.222230 |
| −0.046190 | 0.189400 | 8.222230 |
| −0.011577 | 0.171228 | 8.222230 |
| 0.021390 | 0.150222 | 8.222230 |
| 0.052719 | 0.126832 | 8.222230 |
| 0.082482 | 0.101457 | 8.222230 |
| 0.110812 | 0.074505 | 8.222230 |
| 0.137835 | 0.046243 | 8.222230 |
| 0.163678 | 0.016897 | 8.222230 |
| 0.188460 | −0.013353 | 8.222230 |
| 0.212282 | −0.044367 | 8.222230 |
| 0.235234 | −0.076032 | 8.222230 |
| 0.257405 | −0.108245 | 8.222230 |
| 0.278135 | −0.139859 | 8.222230 |
| 0.297562 | −0.170759 | 8.222230 |
| 0.315782 | −0.200873 | 8.222230 |
| 0.332888 | −0.230133 | 8.222230 |
| 0.348954 | −0.258486 | 8.222230 |
| 0.364047 | −0.285891 | 8.222230 |
| 0.378227 | −0.312309 | 8.222230 |
| 0.390945 | −0.336550 | 8.222230 |
| 0.402271 | −0.358580 | 8.222230 |
| 0.412267 | −0.378358 | 8.222230 |
| 0.420980 | −0.395862 | 8.222230 |
| 0.428453 | −0.411066 | 8.222230 |
| 0.434720 | −0.423955 | 8.222230 |
| 0.440034 | −0.434988 | 8.222230 |
| 0.444470 | −0.444274 | 8.222230 |
| 0.448100 | −0.451923 | 8.222230 |
| 0.450990 | −0.458049 | 8.222230 |
| 0.452247 | −0.463071 | 8.222230 |
| 0.451612 | −0.466969 | 8.222230 |
| 0.450193 | −0.469764 | 8.222230 |
| 0.448486 | −0.471668 | 8.222230 |
| 0.446872 | −0.472907 | 8.222230 |
| −0.429951 | 0.081421 | 8.222230 |
| −0.428110 | 0.080281 | 8.222230 |
| −0.425643 | 0.079171 | 8.222230 |
| −0.422545 | 0.078211 | 8.222230 |
| −0.418286 | 0.077432 | 8.222230 |
| −0.412675 | 0.076997 | 8.222230 |
| −0.405639 | 0.076988 | 8.222230 |
| −0.397096 | 0.077408 | 8.222230 |
| −0.386938 | 0.078084 | 8.222230 |
| −0.375036 | 0.078578 | 8.222230 |
| −0.360958 | 0.078654 | 8.222230 |
| −0.344725 | 0.078083 | 8.222230 |
| −0.326371 | 0.076658 | 8.222230 |
| −0.305948 | 0.074175 | 8.222230 |
| −0.283517 | 0.070441 | 8.222230 |
| −0.259152 | 0.065277 | 8.222230 |
| −0.233973 | 0.058834 | 8.222230 |
| −0.208032 | 0.051090 | 8.222230 |
| −0.181376 | 0.042024 | 8.222230 |
| −0.154052 | 0.031620 | 8.222230 |
| −0.126108 | 0.019852 | 8.222230 |
| −0.097592 | 0.006694 | 8.222230 |
| −0.068556 | −0.007879 | 8.222230 |
| −0.039999 | −0.023368 | 8.222230 |
| −0.011930 | −0.039724 | 8.222230 |
| 0.015644 | −0.056903 | 8.222230 |
| 0.042714 | −0.074869 | 8.222230 |
| 0.069273 | −0.093579 | 8.222230 |
| 0.095317 | −0.113000 | 8.222230 |
| 0.120841 | −0.133098 | 8.222230 |
| 0.145846 | −0.153839 | 8.222230 |
| 0.170332 | −0.175191 | 8.222230 |
| 0.194304 | −0.197120 | 8.222230 |
| 0.217772 | −0.219584 | 8.222230 |
| 0.239987 | −0.241785 | 8.222230 |
| 0.261012 | −0.263634 | 8.222230 |
| 0.280903 | −0.285065 | 8.222230 |
| 0.299718 | −0.306013 | 8.222230 |
| 0.317510 | −0.326419 | 8.222230 |
| 0.334332 | −0.346233 | 8.222230 |
| 0.350230 | −0.365406 | 8.222230 |
| 0.364572 | −0.383056 | 8.222230 |
| 0.377413 | −0.399138 | 8.222230 |
| 0.388806 | −0.413600 | 8.222230 |
| 0.398784 | −0.426416 | 8.222230 |
| 0.407383 | −0.437552 | 8.222230 |
| 0.414625 | −0.446997 | 8.222230 |
| 0.420788 | −0.455086 | 8.222230 |
| 0.425949 | −0.461896 | 8.222230 |
| 0.430183 | −0.467508 | 8.222230 |
| 0.433872 | −0.471721 | 8.222230 |
| 0.437498 | −0.473988 | 8.222230 |
| 0.440687 | −0.474558 | 8.222230 |
| 0.443368 | −0.474318 | 8.222230 |
| 0.445399 | −0.473665 | 8.222230 |
| −0.406732 | 0.134464 | 9.280770 |
| −0.407841 | 0.135985 | 9.280770 |
| −0.408975 | 0.138225 | 9.280770 |
| −0.409751 | 0.141257 | 9.280770 |
| −0.409801 | 0.144993 | 9.280770 |
| −0.408677 | 0.149863 | 9.280770 |
| −0.405878 | 0.155737 | 9.280770 |
| −0.401243 | 0.162422 | 9.280770 |
| −0.394652 | 0.169801 | 9.280770 |
| −0.386003 | 0.177793 | 9.280770 |
| −0.375161 | 0.186309 | 9.280770 |
| −0.361648 | 0.195417 | 9.280770 |
| −0.345327 | 0.204750 | 9.280770 |
| −0.326109 | 0.213960 | 9.280770 |
| −0.303903 | 0.222560 | 9.280770 |
| −0.278617 | 0.229824 | 9.280770 |
| −0.250255 | 0.234958 | 9.280770 |
| −0.220254 | 0.237097 | 9.280770 |
| −0.188953 | 0.235855 | 9.280770 |
| −0.156747 | 0.230955 | 9.280770 |
| −0.124060 | 0.222253 | 9.280770 |
| −0.091297 | 0.209715 | 9.280770 |
| −0.058796 | 0.193450 | 9.280770 |
| −0.026819 | 0.173669 | 9.280770 |
| 0.003491 | 0.151415 | 9.280770 |
| 0.032224 | 0.127162 | 9.280770 |
| 0.059503 | 0.101283 | 9.280770 |
| 0.085468 | 0.074071 | 9.280770 |
| 0.110289 | 0.045817 | 9.280770 |
| 0.134098 | 0.016709 | 9.280770 |
| 0.156996 | −0.013125 | 9.280770 |
| 0.179074 | −0.043571 | 9.280770 |
| 0.200414 | −0.074538 | 9.280770 |
| 0.221079 | −0.105963 | 9.280770 |
| 0.241142 | −0.137772 | 9.280770 |
| 0.260000 | −0.168855 | 9.280770 |
| 0.277753 | −0.199137 | 9.280770 |
| 0.294478 | −0.228564 | 9.280770 |
| 0.310243 | −0.257093 | 9.280770 |
| 0.325108 | −0.284684 | 9.280770 |
| 0.339123 | −0.311309 | 9.280770 |
| 0.352334 | −0.336938 | 9.280770 |
| 0.364218 | −0.360431 | 9.280770 |
| 0.374830 | −0.381757 | 9.280770 |
| 0.384218 | −0.400890 | 9.280770 |
| 0.392418 | −0.417811 | 9.280770 |
| 0.399463 | −0.432502 | 9.280770 |
| 0.405381 | −0.444950 | 9.280770 |
| 0.410405 | −0.455602 | 9.280770 |
| 0.414604 | −0.464565 | 9.280770 |
| 0.418042 | −0.471946 | 9.280770 |
| 0.420783 | −0.477855 | 9.280770 |
| 0.421939 | −0.482694 | 9.280770 |
| 0.421276 | −0.486437 | 9.280770 |
| 0.419871 | −0.489098 | 9.280770 |
| 0.418199 | −0.490900 | 9.280770 |
| 0.416623 | −0.492066 | 9.280770 |
| −0.405637 | 0.133281 | 9.280770 |
| −0.404008 | 0.131880 | 9.280770 |
| −0.401752 | 0.130426 | 9.280770 |
| −0.398837 | 0.129065 | 9.280770 |
| −0.394740 | 0.127783 | 9.280770 |
| −0.389246 | 0.126791 | 9.280770 |
| −0.382294 | 0.126185 | 9.280770 |
| −0.373812 | 0.125945 | 9.280770 |
| −0.363713 | 0.125830 | 9.280770 |
| −0.351902 | 0.125422 | 9.280770 |
| −0.337973 | 0.124408 | 9.280770 |
| −0.321970 | 0.122512 | 9.280770 |
| −0.303958 | 0.119501 | 9.280770 |
| −0.284012 | 0.115171 | 9.280770 |
| −0.262222 | 0.109336 | 9.280770 |
| −0.238685 | 0.101821 | 9.280770 |
| −0.214501 | 0.092882 | 9.280770 |
| −0.189724 | 0.082517 | 9.280770 |
| −0.164407 | 0.070717 | 9.280770 |
| −0.138600 | 0.057476 | 9.280770 |
| −0.112354 | 0.042781 | 9.280770 |
| −0.085721 | 0.026614 | 9.280770 |
| −0.058754 | 0.008964 | 9.280770 |
| −0.032375 | −0.009554 | 9.280770 |
| −0.006579 | −0.028873 | 9.280770 |
| 0.018640 | −0.048942 | 9.280770 |
| 0.043293 | −0.069705 | 9.280770 |
| 0.067395 | −0.091103 | 9.280770 |
| 0.090962 | −0.113087 | 9.280770 |
| 0.114015 | −0.135611 | 9.280770 |
| 0.136576 | −0.158629 | 9.280770 |
| 0.158668 | −0.182096 | 9.280770 |
| 0.180317 | −0.205974 | 9.280770 |
| 0.201556 | −0.230216 | 9.280770 |
| 0.221722 | −0.253966 | 9.280770 |
| 0.240885 | −0.277155 | 9.280770 |
| 0.259100 | −0.299730 | 9.280770 |
| 0.276423 | −0.321644 | 9.280770 |
| 0.292902 | −0.342853 | 9.280770 |
| 0.308579 | −0.363325 | 9.280770 |
| 0.323492 | −0.383028 | 9.280770 |
| 0.337032 | −0.401075 | 9.280770 |
| 0.349230 | −0.417447 | 9.280770 |
| 0.360118 | −0.432111 | 9.280770 |
| 0.369705 | −0.445061 | 9.280770 |
| 0.378010 | −0.456279 | 9.280770 |
| 0.385033 | −0.465768 | 9.280770 |
| 0.391031 | −0.473876 | 9.280770 |
| 0.396070 | −0.480691 | 9.280770 |
| 0.400215 | −0.486297 | 9.280770 |
| 0.403786 | −0.490552 | 9.280770 |
| 0.407311 | −0.492920 | 9.280770 |
| 0.410457 | −0.493574 | 9.280770 |
| 0.413123 | −0.493399 | 9.280770 |
| 0.415150 | −0.492792 | 9.280770 |
| −0.382600 | 0.183894 | 10.490160 |
| −0.383249 | 0.185582 | 10.490160 |
| −0.383746 | 0.187944 | 10.490160 |
| −0.383731 | 0.190953 | 10.490160 |
| −0.382915 | 0.194456 | 10.490160 |
| −0.380860 | 0.198797 | 10.490160 |
| −0.377106 | 0.203807 | 10.490160 |
| −0.371543 | 0.209308 | 10.490160 |
| −0.364064 | 0.215189 | 10.490160 |
| −0.354569 | 0.221360 | 10.490160 |
| −0.342935 | 0.227707 | 10.490160 |
| −0.328663 | 0.234170 | 10.490160 |
| −0.311663 | 0.240314 | 10.490160 |
| −0.291895 | 0.245699 | 10.490160 |
| −0.269362 | 0.249742 | 10.490160 |
| −0.244144 | 0.251712 | 10.490160 |
| −0.216453 | 0.250915 | 10.490160 |
| −0.187816 | 0.246922 | 10.490160 |
| −0.158606 | 0.239581 | 10.490160 |
| −0.129180 | 0.228843 | 10.490160 |
| −0.099854 | 0.214770 | 10.490160 |
| −0.070880 | 0.197497 | 10.490160 |
| −0.042434 | 0.177203 | 10.490160 |
| −0.014604 | 0.154125 | 10.490160 |
| 0.011740 | 0.129362 | 10.490160 |
| 0.036767 | 0.103270 | 10.490160 |
| 0.060637 | 0.076116 | 10.490160 |
| 0.083476 | 0.048082 | 10.490160 |
| 0.105436 | 0.019357 | 10.490160 |
| 0.126630 | −0.009936 | 10.490160 |
| 0.147129 | −0.039721 | 10.490160 |
| 0.167000 | −0.069930 | 10.490160 |
| 0.186302 | −0.100504 | 10.490160 |
| 0.205081 | −0.131404 | 10.490160 |
| 0.223390 | −0.162583 | 10.490160 |
| 0.240672 | −0.192965 | 10.490160 |
| 0.257005 | −0.222498 | 10.490160 |
| 0.272447 | −0.251143 | 10.490160 |
| 0.287048 | −0.278871 | 10.490160 |
| 0.300857 | −0.305652 | 10.490160 |
| 0.313910 | −0.331467 | 10.490160 |
| 0.326244 | −0.356293 | 10.490160 |
| 0.337363 | −0.379031 | 10.490160 |
| 0.347311 | −0.399660 | 10.490160 |
| 0.356126 | −0.418157 | 10.490160 |
| 0.363836 | −0.434508 | 10.490160 |
| 0.370470 | −0.448698 | 10.490160 |
| 0.376047 | −0.460719 | 10.490160 |
| 0.380787 | −0.471003 | 10.490160 |
| 0.384752 | −0.479653 | 10.490160 |
| 0.388001 | −0.486776 | 10.490160 |
| 0.390592 | −0.492477 | 10.490160 |
| 0.391657 | −0.497142 | 10.490160 |
| 0.390975 | −0.500732 | 10.490160 |
| 0.389590 | −0.503264 | 10.490160 |
| 0.387953 | −0.504970 | 10.490160 |
| 0.386416 | −0.506067 | 10.490160 |
| −0.381865 | 0.182473 | 10.490160 |
| −0.380655 | 0.180719 | 10.490160 |
| −0.378832 | 0.178778 | 10.490160 |
| −0.376317 | 0.176815 | 10.490160 |
| −0.372612 | 0.174722 | 10.490160 |
| −0.367449 | 0.172719 | 10.490160 |
| −0.360767 | 0.170915 | 10.490160 |
| −0.352510 | 0.169283 | 10.490160 |
| −0.342632 | 0.167607 | 10.490160 |
| −0.331087 | 0.165572 | 10.490160 |
| −0.317508 | 0.162821 | 10.490160 |
| −0.301979 | 0.159029 | 10.490160 |
| −0.284582 | 0.153973 | 10.490160 |
| −0.265404 | 0.147480 | 10.490160 |
| −0.244540 | 0.139387 | 10.490160 |
| −0.222098 | 0.129535 | 10.490160 |
| −0.199130 | 0.118281 | 10.490160 |
| −0.175694 | 0.105609 | 10.490160 |
| −0.151842 | 0.091508 | 10.490160 |
| −0.127626 | 0.075968 | 10.490160 |
| −0.103100 | 0.058975 | 10.490160 |
| −0.078315 | 0.040512 | 10.490160 |
| −0.053322 | 0.020573 | 10.490160 |
| −0.028972 | −0.000145 | 10.490160 |
| −0.005243 | −0.021572 | 10.490160 |
| 0.017882 | −0.043648 | 10.490160 |
| 0.040428 | −0.066320 | 10.490160 |
| 0.062422 | −0.089525 | 10.490160 |
| 0.083901 | −0.113206 | 10.490160 |
| 0.104889 | −0.137325 | 10.490160 |
| 0.125425 | −0.161830 | 10.490160 |
| 0.145547 | −0.186676 | 10.490160 |
| 0.165290 | −0.211825 | 10.490160 |
| 0.184700 | −0.237231 | 10.490160 |
| 0.203173 | −0.262009 | 10.490160 |
| 0.220782 | −0.286101 | 10.490160 |
| 0.237579 | −0.309465 | 10.490160 |
| 0.253612 | −0.332066 | 10.490160 |
| 0.268925 | −0.353869 | 10.490160 |
| 0.283551 | −0.374853 | 10.490160 |
| 0.297524 | −0.394993 | 10.490160 |
| 0.310261 | −0.413396 | 10.490160 |
| 0.321778 | −0.430056 | 10.490160 |
| 0.332094 | −0.444950 | 10.490160 |
| 0.341207 | −0.458081 | 10.490160 |
| 0.349125 | −0.469438 | 10.490160 |
| 0.355838 | −0.479033 | 10.490160 |
| 0.361583 | −0.487222 | 10.490160 |
| 0.366418 | −0.494098 | 10.490160 |
| 0.370401 | −0.499750 | 10.490160 |
| 0.373792 | −0.504097 | 10.490160 |
| 0.377177 | −0.506616 | 10.490160 |
| 0.380266 | −0.507391 | 10.490160 |
| 0.382916 | −0.507303 | 10.490160 |
| 0.384940 | −0.506756 | 10.490160 |
| −0.358846 | 0.228088 | 11.869830 |
| −0.358810 | 0.229828 | 11.869830 |
| −0.358430 | 0.232116 | 11.869830 |
| −0.357473 | 0.234850 | 11.869830 |
| −0.355778 | 0.237876 | 11.869830 |
| −0.352855 | 0.241465 | 11.869830 |
| −0.348328 | 0.245441 | 11.869830 |
| −0.342056 | 0.249608 | 11.869830 |
| −0.333923 | 0.253810 | 11.869830 |
| −0.323828 | 0.257908 | 11.869830 |
| −0.311664 | 0.261731 | 11.869830 |
| −0.296963 | 0.265061 | 11.869830 |
| −0.279733 | 0.267437 | 11.869830 |
| −0.260044 | 0.268323 | 11.869830 |
| −0.238054 | 0.267129 | 11.869830 |
| −0.214025 | 0.263279 | 11.869830 |
| −0.188300 | 0.256295 | 11.869830 |
| −0.162337 | 0.246301 | 11.869830 |
| −0.136389 | 0.233393 | 11.869830 |
| −0.110641 | 0.217719 | 11.869830 |
| −0.085209 | 0.199467 | 11.869830 |
| −0.060159 | 0.178821 | 11.869830 |
| −0.035522 | 0.155937 | 11.869830 |
| −0.011284 | 0.130983 | 11.869830 |
| 0.011847 | 0.104998 | 11.869830 |
| 0.034019 | 0.078192 | 11.869830 |
| 0.055346 | 0.050709 | 11.869830 |
| 0.075901 | 0.022640 | 11.869830 |
| 0.095776 | −0.005913 | 11.869830 |
| 0.115048 | −0.034876 | 11.869830 |
| 0.133762 | −0.064202 | 11.869830 |
| 0.151970 | −0.093847 | 11.869830 |
| 0.169719 | −0.123768 | 11.869830 |
| 0.187039 | −0.153940 | 11.869830 |
| 0.203974 | −0.184329 | 11.869830 |
| 0.220003 | −0.213893 | 11.869830 |
| 0.235188 | −0.242594 | 11.869830 |
| 0.249576 | −0.270403 | 11.869830 |
| 0.263204 | −0.297299 | 11.869830 |
| 0.276110 | −0.323259 | 11.869830 |
| 0.288327 | −0.348266 | 11.869830 |
| 0.299887 | −0.372303 | 11.869830 |
| 0.310321 | −0.394307 | 11.869830 |
| 0.319664 | −0.414263 | 11.869830 |
| 0.327950 | −0.432152 | 11.869830 |
| 0.335202 | −0.447962 | 11.869830 |
| 0.341445 | −0.461679 | 11.869830 |
| 0.346697 | −0.473298 | 11.869830 |
| 0.351162 | −0.483236 | 11.869830 |
| 0.354899 | −0.491595 | 11.869830 |
| 0.357962 | −0.498477 | 11.869830 |
| 0.360405 | −0.503985 | 11.869830 |
| 0.361384 | −0.508489 | 11.869830 |
| 0.360693 | −0.511931 | 11.869830 |
| 0.359330 | −0.514343 | 11.869830 |
| 0.357729 | −0.515958 | 11.869830 |
| 0.356230 | −0.516990 | 11.869830 |
| −0.358701 | 0.226508 | 11.869830 |
| −0.358235 | 0.224445 | 11.869830 |
| −0.357241 | 0.221998 | 11.869830 |
| −0.355573 | 0.219311 | 11.869830 |
| −0.352770 | 0.216156 | 11.869830 |
| −0.348498 | 0.212703 | 11.869830 |
| −0.342667 | 0.209081 | 11.869830 |
| −0.335211 | 0.205330 | 11.869830 |
| −0.326088 | 0.201392 | 11.869830 |
| −0.315267 | 0.197132 | 11.869830 |
| −0.302447 | 0.192174 | 11.869830 |
| −0.287783 | 0.186134 | 11.869830 |
| −0.271375 | 0.178799 | 11.869830 |
| −0.253293 | 0.170051 | 11.869830 |
| −0.233625 | 0.159753 | 11.869830 |
| −0.212470 | 0.147765 | 11.869830 |
| −0.190827 | 0.134520 | 11.869830 |
| −0.168759 | 0.119975 | 11.869830 |
| −0.146325 | 0.104092 | 11.869830 |
| −0.123584 | 0.086840 | 11.869830 |
| −0.100595 | 0.068191 | 11.869830 |
| −0.077410 | 0.048130 | 11.869830 |
| −0.054076 | 0.026648 | 11.869830 |
| −0.031383 | 0.004489 | 11.869830 |
| −0.009306 | −0.018283 | 11.869830 |
| 0.012185 | −0.041608 | 11.869830 |
| 0.033118 | −0.065438 | 11.869830 |
| 0.053529 | −0.089715 | 11.869830 |
| 0.073455 | −0.114391 | 11.869830 |
| 0.092924 | −0.139430 | 11.869830 |
| 0.111978 | −0.164787 | 11.869830 |
| 0.130659 | −0.190419 | 11.869830 |
| 0.149002 | −0.216295 | 11.869830 |
| 0.167050 | −0.242377 | 11.869830 |
| 0.184241 | −0.267765 | 11.869830 |
| 0.200644 | −0.292409 | 11.869830 |
| 0.216305 | −0.316275 | 11.869830 |
| 0.231272 | −0.339332 | 11.869830 |
| 0.245585 | −0.361553 | 11.869830 |
| 0.259268 | −0.382922 | 11.869830 |
| 0.272345 | −0.403424 | 11.869830 |
| 0.284274 | −0.422149 | 11.869830 |
| 0.295071 | −0.439094 | 11.869830 |
| 0.304750 | −0.454239 | 11.869830 |
| 0.313306 | −0.467588 | 11.869830 |
| 0.320744 | −0.479134 | 11.869830 |
| 0.327054 | −0.488887 | 11.869830 |
| 0.332456 | −0.497212 | 11.869830 |
| 0.337004 | −0.504201 | 11.869830 |
| 0.340752 | −0.509946 | 11.869830 |
| 0.343890 | −0.514430 | 11.869830 |
| 0.347083 | −0.517147 | 11.869830 |
| 0.350098 | −0.518089 | 11.869830 |
| 0.352729 | −0.518117 | 11.869830 |
| 0.354751 | −0.517639 | 11.869830 |
| −0.342285 | 0.254022 | 12.941541 |
| −0.341777 | 0.255645 | 12.941541 |
| −0.340851 | 0.257713 | 12.941541 |
| −0.339339 | 0.260105 | 12.941541 |
| −0.337144 | 0.262694 | 12.941541 |
| −0.333747 | 0.265692 | 12.941541 |
| −0.328834 | 0.268938 | 12.941541 |
| −0.322229 | 0.272181 | 12.941541 |
| −0.313814 | 0.275210 | 12.941541 |
| −0.303500 | 0.277840 | 12.941541 |
| −0.291201 | 0.279865 | 12.941541 |
| −0.276514 | 0.280963 | 12.941541 |
| −0.259519 | 0.280692 | 12.941541 |
| −0.240390 | 0.278501 | 12.941541 |
| −0.219391 | 0.273815 | 12.941541 |
| −0.196863 | 0.266197 | 12.941541 |
| −0.173199 | 0.255300 | 12.941541 |
| −0.149711 | 0.241609 | 12.941541 |
| −0.126524 | 0.225345 | 12.941541 |
| −0.103672 | 0.206755 | 12.941541 |
| −0.081118 | 0.186087 | 12.941541 |
| −0.058787 | 0.163550 | 12.941541 |
| −0.036615 | 0.139295 | 12.941541 |
| −0.014548 | 0.113435 | 12.941541 |
| 0.006765 | 0.086949 | 12.941541 |
| 0.027417 | 0.059946 | 12.941541 |
| 0.047454 | 0.032484 | 12.941541 |
| 0.066885 | 0.004587 | 12.941541 |
| 0.085741 | −0.023700 | 12.941541 |
| 0.104067 | −0.052333 | 12.941541 |
| 0.121898 | −0.081277 | 12.941541 |
| 0.139276 | −0.110496 | 12.941541 |
| 0.156239 | −0.139957 | 12.941541 |
| 0.172813 | −0.169640 | 12.941541 |
| 0.189033 | −0.199517 | 12.941541 |
| 0.204400 | −0.228566 | 12.941541 |
| 0.218968 | −0.256754 | 12.941541 |
| 0.232780 | −0.284056 | 12.941541 |
| 0.245870 | −0.310452 | 12.941541 |
| 0.258270 | −0.335924 | 12.941541 |
| 0.270010 | −0.360457 | 12.941541 |
| 0.281119 | −0.384035 | 12.941541 |
| 0.291147 | −0.405616 | 12.941541 |
| 0.300130 | −0.425186 | 12.941541 |
| 0.308097 | −0.442726 | 12.941541 |
| 0.315071 | −0.458226 | 12.941541 |
| 0.321075 | −0.471675 | 12.941541 |
| 0.326126 | −0.483065 | 12.941541 |
| 0.330420 | −0.492808 | 12.941541 |
| 0.334013 | −0.501002 | 12.941541 |
| 0.336959 | −0.507748 | 12.941541 |
| 0.339309 | −0.513148 | 12.941541 |
| 0.340253 | −0.517553 | 12.941541 |
| 0.339569 | −0.520914 | 12.941541 |
| 0.338225 | −0.523261 | 12.941541 |
| 0.336648 | −0.524825 | 12.941541 |
| 0.335172 | −0.525819 | 12.941541 |
| −0.342569 | 0.252466 | 12.941541 |
| −0.342701 | 0.250362 | 12.941541 |
| −0.342459 | 0.247743 | 12.941541 |
| −0.341642 | 0.244699 | 12.941541 |
| −0.339811 | 0.240907 | 12.941541 |
| −0.336623 | 0.236466 | 12.941541 |
| −0.331900 | 0.231524 | 12.941541 |
| −0.325537 | 0.226171 | 12.941541 |
| −0.317451 | 0.220459 | 12.941541 |
| −0.307563 | 0.214423 | 12.941541 |
| −0.295610 | 0.207738 | 12.941541 |
| −0.281799 | 0.200058 | 12.941541 |
| −0.266300 | 0.191085 | 12.941541 |
| −0.249153 | 0.180759 | 12.941541 |
| −0.230434 | 0.168968 | 12.941541 |
| −0.210238 | 0.155582 | 12.941541 |
| −0.189529 | 0.141077 | 12.941541 |
| −0.168378 | 0.125385 | 12.941541 |
| −0.146855 | 0.108446 | 12.941541 |
| −0.125030 | 0.090208 | 12.941541 |
| −0.102962 | 0.070636 | 12.941541 |
| −0.080713 | 0.049700 | 12.941541 |
| −0.058327 | 0.027392 | 12.941541 |
| −0.036559 | 0.004480 | 12.941541 |
| −0.015388 | −0.018983 | 12.941541 |
| 0.005224 | −0.042940 | 12.941541 |
| 0.025309 | −0.067343 | 12.941541 |
| 0.044904 | −0.092139 | 12.941541 |
| 0.064043 | −0.117288 | 12.941541 |
| 0.082747 | −0.142762 | 12.941541 |
| 0.101058 | −0.168522 | 12.941541 |
| 0.119019 | −0.194527 | 12.941541 |
| 0.136658 | −0.220751 | 12.941541 |
| 0.154011 | −0.247165 | 12.941541 |
| 0.170535 | −0.272862 | 12.941541 |
| 0.186292 | −0.297798 | 12.941541 |
| 0.201327 | −0.321944 | 12.941541 |
| 0.215684 | −0.345270 | 12.941541 |
| 0.229400 | −0.367754 | 12.941541 |
| 0.242498 | −0.389380 | 12.941541 |
| 0.255000 | −0.410136 | 12.941541 |
| 0.266391 | −0.429101 | 12.941541 |
| 0.276688 | −0.446270 | 12.941541 |
| 0.285909 | −0.461624 | 12.941541 |
| 0.294052 | −0.475163 | 12.941541 |
| 0.301125 | −0.486879 | 12.941541 |
| 0.307121 | −0.496781 | 12.941541 |
| 0.312252 | −0.505235 | 12.941541 |
| 0.316569 | −0.512334 | 12.941541 |
| 0.320125 | −0.518171 | 12.941541 |
| 0.323056 | −0.522776 | 12.941541 |
| 0.326090 | −0.525657 | 12.941541 |
| 0.329043 | −0.526740 | 12.941541 |
| 0.331660 | −0.526863 | 12.941541 |
| 0.333687 | −0.526440 | 12.941541 |

Furthermore, the aerodynamic profile of the blade according to the invention is obtained with the values of Table I by stacking together the series of closed curves 20 and connecting them so as to obtain a continuous aerodynamic profile.

To take into account the dimensional variability of each blade 1, preferably obtained by means of a melting process, the profile of each blade 1 can have a tolerance of +/−0.3 mm in a normal direction with the profile of the blade 1 itself.

The profile of each blade 1 can also comprise a coating, subsequently applied and such as to vary the profile itself.

Preferably, said anti-wear coating has a thickness defined in a normal direction with each surface of the blade and ranging from 0 to 0.5 mm.

Furthermore, it is evident that the values of the coordinates of Table I can be multiplied or divided by a corrective constant to obtain a profile in a greater or smaller scale, maintaining the same form.

It can thus be seen that a rotor blade for a first phase of a gas turbine according to the present invention achieves the objectives indicated above.

What is claimed is:

1. A blade (1) of a rotor for a first phase of a gas turbine having a profile identified by means of a series of closed intersection curves (20) between the profile itself and planes (X,Y) lying at distances (Z) from the central axis, each closed curve (20) has a first rounded end (21) and a second rounded end (22) which connect the trace of the first surface (3) with the trace of the second surface (5) in depression, said first end (21) first meets a gas flow of the turbine, each closed curve (20) has an axial chord (40) defined as the maximum distance of the first end (21) from the second end (22) along the axis (X), each closed curve (20) has a thickness (30) of said first end (21) defined as the maximum diameter of the circle inscribed in the first end (21), characterized in that said dimensionless thickness (30), i.e. divided by the axial chord (40), has a quadric distribution according to a curve of the fourth order along the axis (Z).

2. The blade (1) according to claim 1, characterized in that said closed curves (20) are defined according to Table I, whose values refer to a room temperature profile and for each closed curve (20) are divided by value, expressed in millimetres, of the respective axial chord (40).

3. The blade (1) according to claim 1 or 2, characterized in that the profile of each blade (1) has a tolerance of +/−0.3 mm in a normal direction with the profile of the blade (1) itself.

4. The blade (1) according to any of the claims from 1 to 3, characterized in that the profile of each blade (1) comprises an anti-wear coating.

5. The blade (1) according to claim 4, characterized in that said coating has a thickness ranging from 0 to 0.5 mm.

6. A rotor for a first phase of a turbine comprising a series of blades according to any of the claims from 1 to 5.

7. A rotor blade for a first phase of a gas turbine as previously described and illustrated and for the purposes specified above.
